(19) United States
(12) Patent Application Publication
(10) Pub. No.: US 2014/0324893 A1
(43) Pub. Date: Oct. 30, 2014

(54) SYSTEM FOR MEETING PEOPLE OVER THE INTERNET

(71) Applicant: Artashes Valeryevich Ikonomov, Moscow (RU)

(72) Inventor: Artashes Valeryevich Ikonomov, Moscow (RU)

(21) Appl. No.: 14/362,059

(22) PCT Filed: Jun. 24, 2013
(86) PCT No.: PCT/RU2013/000535

§ 371 Date: May 30, 2014

(30) Foreign Application Priority Data
Jul. 6, 2012 (RU) 2012128369

(51) Int. Cl. G06F 17/30; G06F 3/0481

(52) U.S. Cl. CPC G06F 17/30699; G06F 3/04815
USPC 707/754; 715/757

(57) ABSTRACT

In the field of satisfaction of human necessities, the system for meeting people over an Internet network includes client devices interconnected by means of the Internet network and at least one server having a module for forming virtual likenesses, a module for searching and comparing virtual likenesses, a module for displaying and storing results and a module for communication between virtual likeness. The system can be used in allowing users of social networks to meet each other. The system includes a module for forming and operating virtual meetings scenes. The achieved technical result is a broadening of functional capabilities of the system.

The invention relates to the field of satisfaction of human necessities, specifically to systems for meeting people over the Internet network, comprises client devices interconnected by means of the Internet network and includes at least one server comprising a module for forming virtual likenesses, a module for searching and comparing virtual likenesses, a module for displaying and storing results and a module for communication between virtual likenesses, and can be used in allowing users of social networks to meet each other.

It is known a communication system for meeting other users which comprising client devices interconnected by means of a network and including at least one server, as described in the Russian invention patent No 2279191, published in 2006. Personal transmit and receive user devices perform the function of said client devices. Such personal transmit and receive user devices are built so as to ensure wireless communication with each other via a local controlling device; a central controlling device is based on a computer that comprises software and a user database, and is linked with the local controlling device. Mobile communication terminals are used as personal transmit and receive user devices, a mobile operator station is used as the local controlling device, while a server is used as the central controlling device.

The drawback of the system is that the meetings are accessible only from mobile terminals by verbal manner only; the user has no opportunity to evaluate a prospective partner by other criteria (a photo, blogs, etc) accessible in the Internet meeting systems; the system provides no extensive opportunities for virtual communication after the initial contact.

The above are the factors that limit the use of such system for meeting people over the Internet network.

Another example of prior art is a system for meeting people over the Internet network that comprises client devices interconnected by means of the Internet network and includes at least one server comprising a module for forming virtual likenesses, a module for searching and comparing virtual likenesses, a module for displaying and storing results and a module for communication between virtual likenesses, as described in the Russian invention patent No 2378987, published in 2010.

In this system a user employs a user device connected to the Internet network to launch a browser, enter a dating site address, create a user profile, access a psychological test page and take the test or (if the test has already been taken) view his/her compatibility results as well as to view other related website pages.

The above system also comprises a module for forming virtual likenesses, a module for searching and comparing virtual likenesses, a module for displaying and storing results and a module for communication between virtual likenesses built as separate servers, i.e. a test subsystem server that consists in a test DB server, a computing server and a search server. The test DB server is used for the storage of test questions, user answers, intermediate computing information on each user and interpretation of psychological characteristics and characteristics of an ideal partner and couple compatibility. The computing server is used to compute the surveyed user compatibility ratio with all other surveyed users and to generate factor scales. The search server retrieves and sorts the completed surveys by the user-defined search filters or sorting criteria.

The above device is used herein as a prototype of the claimed invention.

The known solution has a drawback, namely it provides no option for dating in the virtual environment directly where the user can select and assume a variety of 3D likenesses. This limits the usability of the system for meeting people over the Internet.

The present invention relies on this novel observation with the primary aim to offer a system for meeting people over the Internet that serves at least to mitigate the aforementioned drawback, namely, to enhance the usability of the system for meeting people over the Internet.

For this purpose, the system for meeting people over the Internet includes a module for forming and operating virtual meetings scenes.

The above makes it possible to arrange meetings directly in the virtual Internet-based environment.

There is a version of the invention in which the module for forming and operating virtual meetings scenes includes a module for selection and design of user virtual 3D likeness.

The above makes it possible for the user to select and design his individual virtual 3D likeness.

Also, there is a version of the invention in which the module for forming and operating virtual meetings scenes includes a module for selection and design of virtual 3D likeness for virtual meetings scene.

The above makes it possible for the user to select and design a virtual 3D likeness for virtual meetings scene.

Also, there is a version of the invention in which the module for forming and operating virtual meetings scenes includes a module for selection and design of virtual 3D likeness for gifts.

The above makes it possible for the user to select and design a virtual 3D gift for optional use, for example, during a virtual date, to expand the possibilities of the dating process itself.

Also, there is a version of the invention in which the module for forming and operating virtual meetings scenes includes a module for behavior operating of the user virtual 3D likeness.

The above makes it possible for the user to control the actions of his/her virtual 3D likeness during the virtual meeting. This function enables the user to perform a variety of actions adapted to the meeting in the given virtual environment to enhance the usability of the virtual date.

The combination of the essential features of the claimed invention is not known from the prior art, therefore the invention possesses the required feature of novelty.

Other distinguishing features and advantages of the invention are readily apparent from the description below which includes but is not limited to the following features, with reference to the figure attached:

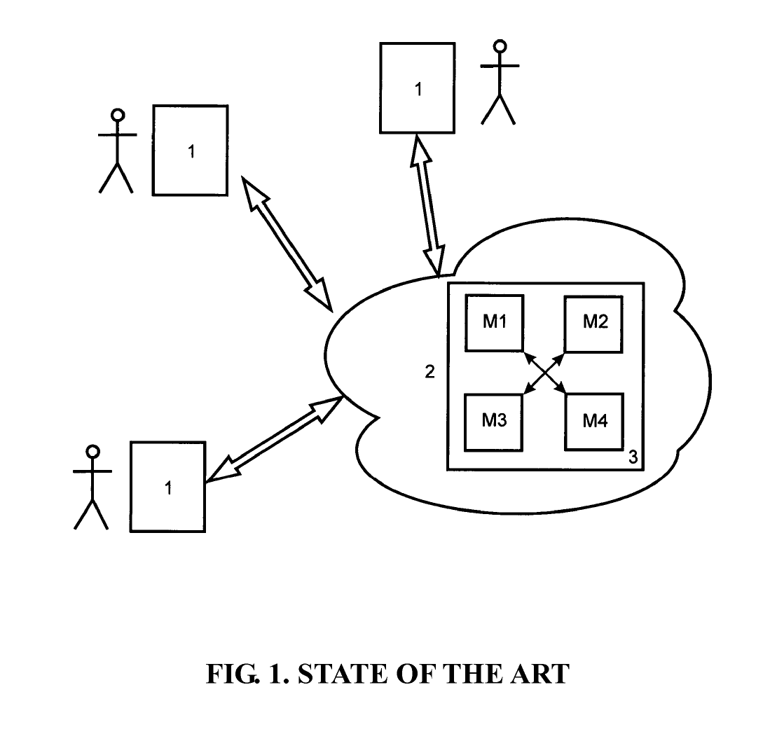

FIG. 1 schematically shows a flowchart of the system for meeting people over the Internet according to the state of the art.

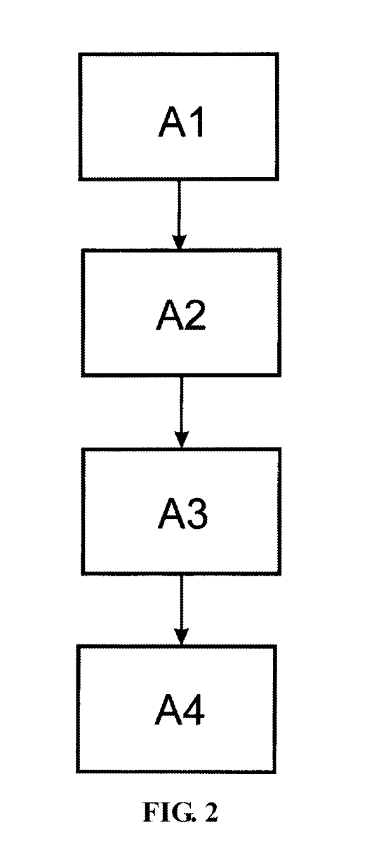

FIG. 2 shows the stages of meeting in the system for meeting people over the Internet network according to the invention.

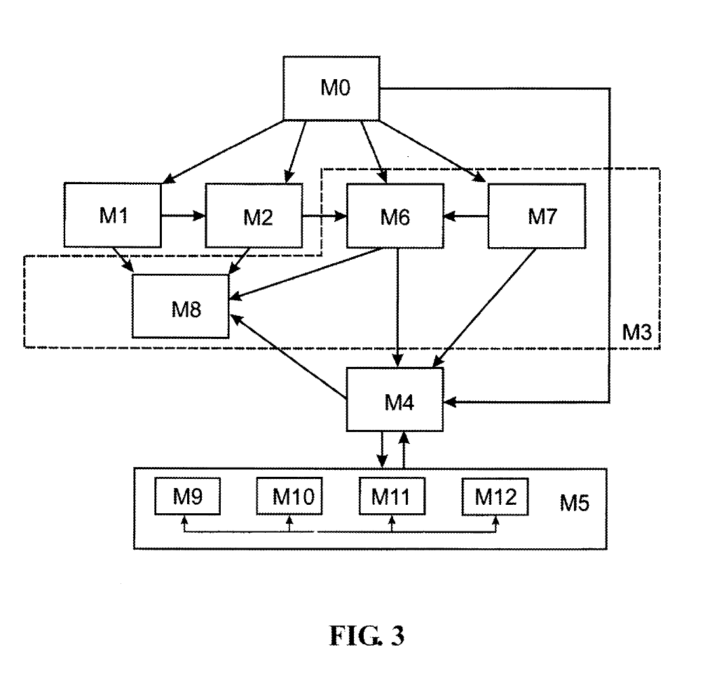

FIG. 3 displays a possible version of the connection flowchart for the modules of the system for meeting people over the Internet network according to the invention.

The system for meeting people over the Internet network comprises (see FIG. 1) client devices 1 interconnected by means of the Internet network 2 including at least one server 3. Said server comprises a module for forming virtual likenesses M1, a module for searching and comparing virtual likenesses M2, a module for displaying and storing results M3 and a module for communication between virtual likenesses M4. According to the invention, the system for meeting people over the Internet network also includes a module for forming and operating virtual meetings scenes M5.

In general, any variety of computing platforms that can be connected to a network such as a unified network and can interact with applications can be a client device 1. Standard examples of some such client devices include but are not limited to desktop and laptop personal computers, smart cellular phones, lightweight clients, workstations, “non-intelligent” terminals connected to the application server and various combinations and configurations of the same that are self-evident for those skilled in the art, i.e. these include both physical devices that ensure interaction as part of communication and virtual devices based on programmable computers and having program interface to enable such communication.

Internet network 2 comprises a multitude of topologies, configurations and arrangements of the internetworking components built so as to connect corporate, global and local computer networks. Such network includes but is not limited to traditional wired and wireless, satellite, optical and equivalent networking technology that are self-evident for those skilled in the art.

The invention functions as follows. The following is the description of how the system for meeting people over the Internet network functions in a social network.

The purpose of the system is to enable searching for the people of interest to the social network user to establish contacts and initiate interaction on the topics of interest to the user. The user's self-presentation and search for the contacts in the network is based on temporary virtual likenesses. The contacts retrieved are based on their temporary virtual likeness, not on the data specified by the users in their alias (nickname) descriptions.

Stage A1. The user utilizes a website page to define his/her virtual (fictional or actual at the user's sole discretion) attributes and the attributes of the looked-for persons.

Stage A2. The information with the attributes and controlling data are entered in the database tables (i.e. attributes proper and the link couple between attribute groups).

Stage A3. The comparison process selects couples, if any, and notifies the currently active user (or both) of finding a client query match.

Stage A4. The users that are inactive, i.e. not on the site, at the moment of successful matching, are notified as soon as they access the site. The number of matching contacts is then displayed.

The system for meeting people over the Internet network consists in the following functional modules according to the state of the art:

M1—Module for forming virtual likenesses.

M2—Module for searching and comparing virtual likenesses that includes a filter of matching attributes of virtual likenesses.

M3—Module for displaying and storing results.

M4—Module for communication between virtual likenesses.

According to this invention, the system for meeting people over the Internet network can also include:

M0—Module for controlling system components and scripts.

M5—Module for forming and operating virtual meetings scenes.

The module for displaying and storing results M3 may comprise:

M6—Module for displaying matching contacts.

M7—Module for displaying query lists and matching virtual likenesses.

M8—Module for storing information on queries, virtual likenesses and search results.

The module for forming and operating virtual meetings scenes M5 may include:

M9—Module for selection and design of user virtual 3D likeness.

M10—Module for selection and design of virtual 3D likeness for virtual meetings scene.

M11—Module for selection and design of virtual 3D likeness for gifts.

M12—Module for behavior operating of user virtual 3D likeness.

The module for controlling system components and scripts M0 is designed to realize a general control of the claimed system. The purpose of this module is to request a system component depending on the scope of the user presence in the social network and his/her selection in the social network interface system.

The module for forming virtual likenesses M1 in the system is designed to provide a new personal virtual likeness other than the virtual likeness previously set by the user in the system or to set an existing system user likeness for the purpose of searching for new contacts and communication partners. The virtual likeness in this system is formed by setting the attributes and features of the likeness such as age, gender, biometrical parameters, hobbies, professional activity, musical and literary taste, etc. Besides, the module for forming virtual likenesses M1 requires the user to describe a looked-for likeness in a social network user by setting the desired attributes and features of such likeness, including its age or age range, gender, biometrical parameters, hobbies (one or several), professional activity, musical and literary tastes, etc.

The user can apply the OR operation to expand the selection while filling in the attributes field. The user also can specify a range of numbers and dates for numerical and date attributes.

For this purpose, the module for forming virtual likenesses M1 establishes a linked couple of virtual likenesses, i.e. a virtual likeness of a user who looks for partners in the system and a virtual likeness (or a plurality of such likenesses if multiple selection options are set) of looked-for users of the social network. The system database generates groups of search attributes using the user-defined values, then the system automatically launches the module for searching and comparing virtual likenesses M2 to execute the user query.

All queries and virtual likenesses generated by the users are stored in the system database. Queries and related virtual likenesses can only be stored for a limited time, after which both query and the related virtual likenesses are deleted.

The module for searching and comparing virtual likenesses M2 executes search scripts in the system.

The user fills in the query form and initiates registration of the query in the query table of the database and the system is ready for searching for matching profiles. If the table also contains other user queries, attribute sets are then compared against each other, i.e. the system checks if the attributes of a second user comply with the requested attributes of a first user and, vice versa, if the attribute set of the first user complies with the requested attributes of the second user. This function is performed by the filter of matching attributes of virtual likenesses.

The above serves to ensure that the system is not limited to the preferences of one user but includes the preferences of the other user. If they match, the couple of users is deemed by the system as prospective communicative partners. The module for searching and comparing virtual likenesses M2 identifies all such couples and creates relevant entries in the database.

The module for displaying matching contacts M6 serves to display the matching contacts in the system. The user is given a list of contacts and an opportunity to send each of them a friend (talk) request.

If the contact accepts the request, the module for displaying matching contacts M6 adds such contact to the user friend list in the social network and deletes it from the list of prospective contacts in the system.

A user can interact with a new contact by means of all communication resources integrated in the social network, i.e. by exchanging text messages or launching audio and video communication devices.

The module for storing information on queries, virtual likenesses and search results M8 serves to store the history of queries, queried virtual likeness and search results. The module retrieves the data from the system database and displays the list of queries over the user-defined period, the lists of matching contacts retrieved over the user-defined period, the lists of contacts matching user-defined attributes, etc, in the user interface.

The module for storing information on queries, virtual likenesses and search results M8 automatically deletes the expired data from the system database.

The module for displaying query lists and matching virtual likenesses M7 serves to select from the system database previously saved search queries, own virtual likenesses and looked-for virtual likenesses of other users. The module for displaying query lists and matching virtual likenesses M7 can generate a list of queries and virtual likenesses over the user-defined period including a user-specified version of own likeness or looked-for likenesses.

The module for communication between virtual likenesses M4 serves to activate communication devices native in the social network such as text messaging, audio and video communication and special interaction tools provided by the module for forming and operating virtual meetings scenes M5. All communication and interaction tools are initialized by the user.

The module for forming and operating virtual meetings scenes M5 serves to generate three-dimensional scenes for virtual meetings of the three-dimensional user likenesses. For this purpose, the system interface has a means of initialization of the module for forming and operating virtual meetings scenes M5 wherein the time and place of the meeting are specified by the module for selection and design of virtual 3D likeness for virtual meetings scene M10. Three-dimensional users' likenesses are selected and edited by the module for selection and design of user virtual 3D likeness M9.

The module for selection and design of virtual 3D likeness for virtual meetings scene M10 enables selection and editing of various three-dimensional scenes that may be represented by 3D cafe, bar and other interiors at the users' option.

Executing the user-selected scenario, the module for forming and operating virtual meetings scenes M5 refers to the module for selection and design of virtual 3D likeness for gifts M11 to enhance the user 3D likenesses with the required assets such as “flowers”, “chocolates”, etc.

A behavior of the 3D likeness in the 3D scene is operated by the user owning the personage in real time by means of the module for behavior operating of user virtual 3D likeness M12. The range of available behavior includes, inter alia, such special functions as a “handshake”, “bow”, “coming closer to the partner”, “sitting down” and others in accordance with the general theme of the virtual meeting. These functions serve to determine and control by the user the behavior of his virtual personage during the virtual meeting. The 3D scene can also include direct audio and video interaction tools available to the meeting users, as well as a text-messaging tool.

The system executes interaction scenarios (patterns) as follows:

Module M0 allows the user to determine the sequence of required system events.

The user initializes the module MO to select an own virtual likeness and a looked-for virtual likeness as executed by the module M1 to be able to initiate search for a client with the looked-for virtual likeness via the module M2.

The module M7 serves to store and control the descriptions of virtual likenesses, search query attributes (date, time, numerical identification attributes), search results (matching client couples by way of cross-comparison, other information). A search query can be stored in the system for a limited time. As soon as this time expires, the claimed system deletes such query.

As soon as the search procedure is completed, the results are visualized by the module M6. The module M6 uses the list of virtual likenesses matching the requirements of the attribute cross-comparison to generate a list of clients eligible for anonymous interaction. The dynamic list is generated with reference to the selected query or the latest search query and the results of the module M2 as stored by the module M7 and is based on fixed criteria: the clients with the Online status from the module M2 results list as stored by the module M7 appear first. All other contacts follow in the order of their respective search queries and virtual likenesses registration (the earlier is the virtual likeness query, the closer the contact is to the beginning of the list).

The list is visualized by parts and can be viewed by scrolling through the contacts.

All contacts in the list are displayed in the anonymous mode in a variety of options, i.e. without userpics, aliases (nicknames) and other identifying information. The contact is defined by the query attribute (own virtual likeness and looked-for virtual likeness) that was used to retrieve the same. Each contact can be used to trace the attributes of the own virtual likeness and the looked-for virtual likeness.

The module M4 serves to send and receive messages to and from the user selected from the dynamic contact list by means of the chat component. The module M4 allows sending a special deanonymization request from the user who originates the contact and, if accepted, adds the recipient to the originator's open friends category.

The module M7 provides a blacklisting option to avoid new requests from abusers (new retrieval or new visualization as a match for an abuser). An abuser's alias (nickname) is then blacklisted.

The modules M6, M8 and M4 have means for activating the module M7 to remove the following from the list of matching contacts:
1) one selected contact;
2) a group of selected contacts from a query;
3) all contacts from a query.

Module M7 monitors validity of the queries and deletes queries and still anonymous contacts.

As soon as the attributes are disclosed, the system registers couples who interacted and marks them as such in the database to prevent any new anonymous sessions between the same users.

In the event that the couple “disliked” each other, the module M4 has a respective “dislike” function, whereupon the module M7 registers such action in the database to prevent new contacts with the marked user. The system generates a new contact list for the originating user who can then browse the list and select a new contact.

The module M4 supports all methods of interaction between the users, i.e. by way of text-messaging, audio and video streaming, which are native to the given social network.

Furthermore, the module M4 serves to activate the module M5 to initiate procedures in 3D-interface of virtual 3D “meetings” based on three-dimensional scenes, three-dimensional user likenesses and behavior scenarios of 3D likenesses in the 3D-scenes. If the users wish to interact in the 3D-scenes, the module M4 ensures connecting native interaction tools and controls to the 3D-scenes.

The above description of exemplary versions of the invention serves to illustrate and characterize said model, but is not meant to be taken as an exhaustive description or a limitation of the inventions by the exact versions described. The above description allows for modifications and alterations that can also be derived from the use of the invention.

Persons skilled in the art also understand that the invention components as described above may be incorporated in a multitude of software varieties, built-in applications and hardware in their respective versions as shown in the diagram. Any real program code or specialized hardware control used for materialization of the objects in accordance with the basic principles of said invention do not serve to limit the invention. Therefore, the invention components and their functionality have been described herein without reference to a specific program code, as it is evident that a person skilled in the art is capable of developing software and controlling hardware to implement such components based on the description as given herein.

A system for meeting people in the environment of the Cafe4tune social network has been made in accordance with the claimed invention. Trial runs of said system for interactive communication demonstrated that the system is capable of matching couples in compliance with their mutual queries, in addition to the search function. The system also has an option that allows to initiate meetings in a virtual environment enhanced by users virtual 3D likenesses and 3D scenes where said meeting takes place, by employing special virtual objects that can serve as gifts, and by a feature of controlling behavior depending on the nature of the meeting, thus achieving the claimed technical result of broadening of functional capabilities of a system for meeting people over the Internet network.

1. System for meeting people over the Internet network, comprising client devices interconnected by means of the Internet network, including at least one server comprising
a module for forming virtual likenesses,
a module for searching and comparing virtual likenesses,
a module for displaying and storing results and
a module for communication between virtual likenesses,
wherein the system for meeting people over the Internet network includes a module for forming and operating virtual meetings scenes.

2. System for meeting people over the Internet network according to claim 1, wherein the module for forming and operating virtual meetings scenes includes at least one of following modules: (a) module for selection and design of user virtual three-dimensional 3D likeness; (b) module for selection and design of virtual three-dimensional likeness for virtual meetings scene ; (c) module for selection and design of virtual three-dimensional likeness for gifts.

3-4. (canceled)

5. System for meeting people over the Internet network according to claim 1, wherein the module for forming and operating virtual meetings scenes includes a module for selection and design of user virtual three-dimensional likeness and a module for behavior operating of user virtual three-dimensional likeness.

6. System for meeting people over the Internet network according to claim 2, wherein it includes a module for controlling system components and scripts adapted to control said system by determining a sequence of required system events.

7. System for meeting people over the Internet network according to claim 6, wherein the module for displaying and storing results comprises at least one of following modules: (a) module for displaying matching contacts; (b) module for displaying query lists and matching virtual likenesses; (c) module for storing information on queries, virtual likenesses and search results.

8. System for meeting people over the Internet network according to claim 7, wherein the module for searching and comparing virtual likenesses includes a filter of matching attributes of virtual likenesses.

9. System for meeting people over the Internet network according to claim 8, wherein said server comprises also a database and wherein queries generated by module for searching and comparing virtual likenesses and related virtual likenesses generated by the module for forming virtual likenesses are stored in the database for a limited time.

10. Method of run of a system for meeting people over the Internet network, said system being adapted to be functioned in a social network and comprising client devices interconnected by means of the Internet network, each client device is adapted to be operated by a user, said system including at least one server comprising a database as well as :
a module for forming virtual likenesses,
a module for searching and comparing virtual likenesses,
a module for displaying and storing results and
a module for communication between virtual likenesses,
wherein the system for meeting people over the Internet network includes a module for forming and operating virtual meetings scenes, and
wherein the method of run comprises:
establishing by the module for forming virtual likenesses of a couple of virtual likenesses, this couple comprising a virtual likeness of a user who looks for a new contact and a looked-for virtual likeness of the said contact, each of said virtual likenesses of the couple being formed with the help of selective user-defined values;
generating groups of search attributes using these user-defined values, these search attributes being adapted to form queries of the user;
storing the virtual likenesses and the query in the database;
automatically launching the module for searching and comparing virtual likenesses adapted to execute the query by executing search scripts;
displaying and storing matched new contacts with the help of the module for displaying and storing results;
interacting in three-dimensional interface of virtual three-dimensional meetings based on three-dimensional scenes between the virtual likeness of the user and the virtual likeness of the matched new contact with the help of the module for forming and operating virtual meetings scenes, this module for forming and operating virtual meetings scenes being activated by the module for communication between virtual likenesses.

11. Method of run according to claim 10, wherein queries and related virtual likenesses are stored for a limited time, after which both query and the related virtual likenesses are deleted.

12. Method of run according to claim 11, wherein the system for meeting people over the Internet network includes a module for controlling system components and scripts adapted to control said system by determining a sequence of required system events, and wherein the method of run comprises initializing of the module for controlling system components and scripts, said initializing being adapted to select the couple of virtual likenesses established by the module for forming virtual likenesses.

13. Method of run according to claim 12, wherein it comprises initializing of the module for forming and operating virtual meetings scenes, said initializing being adapted to generate three-dimensional scenes for virtual meetings of the three-dimensional likenesses.

14. Method of run according to claim 13, wherein the module for forming and operating virtual meetings scenes comprises a module for selection and design of user virtual three-dimensional likeness, and wherein said method of run comprises also selecting and editing of users' virtual three-dimensional likenesses with the help of the module for selection and design of user virtual three-dimensional likeness.

15. Method of run according to claim 14, wherein the module for forming and operating virtual meetings scenes comprises a module for behavior operating of user virtual three-dimensional likeness, and wherein said method of run comprises also determining and operating in real time of behavior of virtual user three-dimensional likeness during the virtual meeting with the help of the module for behavior operating of user virtual three-dimensional likeness.

16. Method of run according to claim 14, wherein the module for forming and operating virtual meetings scenes comprises a module for selection and design of virtual three-dimensional likeness for virtual meetings scene, and wherein said method of run comprises also specifying time and place of the virtual meeting with the help of the module for selection and design of virtual three-dimensional likeness for virtual meetings scene.

17. Method of run according to claim 14, wherein the module for forming and operating virtual meetings scenes includes a module for selection and design of virtual three-dimensional likeness for gifts, and wherein said method of run comprises also enhancing the user three-dimensional likenesses with required assets with the help of the module for selection and design of virtual three-dimensional likeness for gifts.

18. Method of run according to claim 12, wherein the module for searching and comparing virtual likenesses includes a filter of matching attributes of virtual likenesses adapted to check if the attributes of one user looking for a contact comply with the requested attributes of another user looking for a contact and vice versa.

19. Method of run according to claim 18, wherein the module for displaying and storing results includes a module for displaying matching contacts and wherein said method of run comprises also:
displaying a dynamic list of matching contacts eligible for anonymous interaction, the dynamic list is adapted to be generated with reference to the selected query or the latest search query,
sending a talk request to each of said matching contacts from the dynamic list,
if the talk request is accepted by one of said matching contacts, adding this contact to a user friend list and deleting this contact from the dynamic list.

20. Method of run according to claim 19, wherein the module for displaying and storing results includes a module for displaying query lists and matching virtual likenesses, wherein the dynamic list is adapted to be stored by the module for displaying query lists and matching virtual likenesses, and wherein said method of run comprises also:
selecting from the system database previously saved search queries, virtual likenesses of the user who looks for a new contact and a looked-for virtual likeness of the said contact,
providing a blacklisting adapted to avoid new requests from abusers,
monitoring validity of the queries
deleting queries and still anonymous contacts.

21. Method of run according to claim 20, wherein the module for displaying and storing results includes a module for storing information on queries, virtual likenesses and search results, and wherein said method of run comprises also:
storing a history of queries, queried virtual likeness and search results,
retrieving the information on queries, virtual likenesses and search results,
deleting the expired information.

22. Method of run according to claim 21, wherein the module for displaying matching contacts, the module for storing information on queries, virtual likenesses and search results and the module for communication between virtual likenesses have means for activating the module for displaying query lists and matching virtual likenesses, and wherein said method of run comprises also removing from the dynamic list of matching contacts at least one of the following elements: (a) one selected contact; (b) a group of selected contacts from a query; (c) all contacts from a query.
